(19) United States
(12) Patent Application Publication
(10) Pub. No.: US 2024/0061407 A1
(43) Pub. Date: Feb. 22, 2024

(54) APPARATUS AND METHOD FOR INSPECTING CONTAINERS

(71) Applicant: KRONES AG, Neutraubling (DE)

(72) Inventors: Anton NIEDERMEIER, Offenstetten (DE); Christof WILL, Obertraubling (DE); Stefan PIANA, Koefering (DE); Reinhard KLINGER, Bernhardswald (DE)

(21) Appl. No.: 18/235,210

(22) Filed: Aug. 17, 2023

(30) Foreign Application Priority Data
Aug. 17, 2022 (DE) 10 2022 120 823.0

(51) Int. Cl. G05B 19/418; B67C 3/00; B67C 3/24

(52) U.S. Cl. CPC G05B 19/41865; B67C 3/007; B67C 3/24; G05B 2219/39147

(57) ABSTRACT

An apparatus for handling, transporting and inspecting containers along a predetermined transport path, having a first sensor device configured for detecting at least one value characteristic of the transported containers, having a first actuator device arranged along the transport path downstream of the first sensor device and configured for acting upon a transported container and a control device that is spaced apart from the sensor and the actuator device is configured for controlling the first actuator device, wherein at least one output by the first sensor device, as a function of the characteristic value, wherein the first sensor device and actuator are in communication with the control device via a cable using a real-time-capable fieldbus, the first sensor device is configured for outputting data, and the communication between the first sensor device, the control device and/or the control device and the first actuator device is in real time.

### BACKGROUND OF THE INVENTION

The present invention relates to an apparatus and a method for treating and in particular inspecting containers, and in particular beverage containers.

From beverage production, it is known to examine or inspect filled, filled and closed containers, or also containers to be filled as to different aspects. Thus, it is known, for example, to inspect the mouths of such containers as to whether they can be provided with closures or whether they have errors. Fill-level inspections, which check whether a specific container has been filled properly or with a desired or targeted quantity of liquid, are also known. In addition, inspection devices, which inspect the labels of such containers, are also known.

In recent times, such inspection devices often have cameras, which are therefore associated with a high amount of data. Furthermore, the working speeds of such machines are also continuously rising, which also increases the requirements for such inspection systems.

Furthermore, such systems are known from the internal prior art of the applicant, which are constructed similarly to an inspection system, but, as a function, do not perform a quality evaluation of objects produced, and instead serve as a sensor system for the control or regulation of the treatment machine. This can, for example, be the detection of the position (position, angle of rotation, tilt, etc.) for a position control or the correctly positioned triggering of manipulation steps.

Furthermore, it is known that such inspection devices also enable containers that have been detected as faulty, for example, to be rejected. Such discharge devices, such as actuators in particular, must also be able to react quickly and, in some cases, handle large amounts of data.

Various sensor systems for such apparatuses are known from the prior art. For example, simple digital switching or analog measuring sensors, which have a single-cable connection, are known. Thereby, it is known that a voltage supply, which is usually a 24-volt supply, and also a signal line are integrated into a cable.

In addition, simple digital switching or analog measuring sensors, which are connected via IO-Link interfaces, are also known. Some of these are also capable of exchanging complex data with a higher-level computer. However, such apparatuses often have the problem of real-time capability—in particular, when communicating with multiple participants.

Further known are image recording devices, such as cameras with a single-cable connection. This can be connected via Gigabit Ethernet or a Power over Ethernet (PoE), for example. However, such Gigabit Ethernet connections do not allow real-time connectivity in every case.

An illumination for an image processing, which works precisely by means of a fieldbus, is known from EP 3 286 552.

In addition, precise and, in particular, real-time-triggerable image recording devices and, in particular, smart cameras are also known. These return processed results in real-time and also, preferably, ok or not ok classifications from image processing.

However, the procedures described each have different disadvantages. In some cases, such arrangements allow a detection, for example, of an image, but no response to it. With other solutions, only sensor data is supplied. Other solutions provide, by comparison, complex sensor data. Finally, there is often the problem that the instruments do not communicate in real time. Thus, the procedures mentioned from the prior art are not able to allow fast or real-time-capable communication, on the one hand, and a cost-effective and simple design or cabling even for the output of complex data, on the other.

Therefore, the present invention is based upon the object of providing such an apparatus and a method for treating and, in particular, inspecting containers that, on the one hand, is cost-effective, on the other, permits very fast and, in particular, real-time-capable communication, and, finally, also permits the processing and transmission of complex data volumes or data streams—in particular, if a large number of sensor and/or actuator devices are provided.

### SUMMARY OF THE INVENTION

An apparatus according to the invention for treating and in particular inspecting containers and in particular beverage containers has a transport device that is suitable and intended for transporting the containers along a predetermined transport path. Furthermore, the apparatus has a first sensor device, which is arranged in particular along this transport path and which is suitable and intended for detecting at least one value characteristic of the transported containers and in particular a characteristic physical value. Preferably, the sensor device is suitable and intended for detecting the specified value for each of the transported containers. Preferably, the sensor device is suitable and intended for detecting the specified value in a contactless manner and/or optically.

Furthermore, the apparatus has a first actuator device, which is typically arranged along the transport path downstream of the first sensor device and which is suitable and intended for acting (in particular, mechanically) upon a specific transported container (and, in particular, for discharging it from the transport path).

Furthermore, a control device spaced apart from the first sensor device and/or the first actuator device is provided, which control device is suitable and intended for controlling the first actuator device, taking into account at least one signal output by the first sensor device, as a function of the characteristic value and/or as a function of a signal output by the characteristic value (detected by the first sensor device).

According to the invention, the first sensor device and the first actuator device are in communication connection with the control device via a cable connection by means of at least one, real-time-capable fieldbus, and the first sensor device is suitable for outputting measurement data in real time, and the communication between the first sensor device and the control device and/or the control device and the first actuator device takes place in real time.

Therefore, in the context of the invention, data communication via a fieldbus, and, in particular, a real-time fieldbus, is proposed, which allows real-time communication—in particular with very high determinism. In particular, data communication in hard real-time is enabled.

The sensor device is also suitable and intended for the output of data in real time.

Real-time is in particular understood to mean that the sensor device or other devices provide data and/or communicate, wherein such time period or response time is substantially less than 1 second, preferably substantially less than 0.1 seconds, preferably less than 0.05 seconds, preferably less than 0.01 seconds, preferably less than 0.005 seconds, and most preferably less than 0.001 second.

Preferably, the output data is cyclically-output and/or cyclically-detected data. For example, a corresponding data set or corresponding data can be output for each of the transported containers. Furthermore, it is also possible to decide for each individual container whether it is to be discharged from the container flow and/or the transport path.

Therefore, it is proposed to use a sensor device that can also supply more complex sensor measured values, and in particular in real time, and in particular in hard real time, via a fieldbus, and in particular an Ethernet-based fieldbus, to a higher-level evaluation (or the control device), wherein a cable solution and in particular a single-cable solution is preferably provided for this purpose, or the sensor device is connected via a single-cable solution.

Particularly preferably, the sensor device is suitable for outputting more complex sensor measured values. In particular, these are still unqualified sensor measured values (in particular, so-called raw data) such as digitized analog measured values, which are particularly preferably also dependent upon time, e.g., sections of time series (in particular, since the last transmission, in order to thus be able to transmit gapless time series). In addition, these can also be values of sensor arrays or line or matrix sensors. In addition, aggregated multiple sensors may also be provided. However, complex data may also be data that have already been pre-processed decentrally in the sensor, such as X/Y position information or position angle information of containers or the combination thereof.

Preferably, the sensor device is suitable and intended for outputting data in connection with a time value, and/or the control device is suitable and intended for assigning a time value to data output by the sensor device. In the simplest case, the time value consists of the time stamp of the data transmission.

Preferably, the data output by the sensor device can be assigned to a specific container transported by the transport device or is assigned to a specific container.

Preferably, processing and/or evaluation of such sensor data takes place in a higher-level system, and in particular in the above-mentioned control device. In this way, the measurement processes may be accelerated considerably. As mentioned above, the system is suitable and designed to achieve cyclic measurement or processing of data. Particularly preferably, the respective time windows or response times are less than 10 ms and preferably less than 1 ms. Particularly preferably, the response times are in a range between 10 μs and 10 ms.

Preferably, the fieldbus is a standard fieldbus, which in particular can be easily procured. Thereby, it must be taken into account that a corresponding defective fieldbus or also a defective cable interrupts the entire cable harness. Therefore, the fieldbus is preferably a series element that can be procured in large quantities.

Particularly preferably, the actuator device is an ejection device that is suitable and intended for discharging individual containers or groups of containers from the transport path. Thereby, this actuator device is particularly preferably designed in such a way that it is also possible to discharge a single container that has been identified as faulty, for example.

However, the actuator device can also, for example, be a flashed illumination device and/or the sensor device can have such an illumination device, which is intended to precisely illuminate the containers for the camera image recording. Such illuminators for image processing usually feature LED's as light-generating components, which may be controlled with microsecond precision in synchronization with the camera's image recording.

In a further advantageous embodiment, the apparatus has a triggering device that is suitable and intended for triggering a measurement and/or an inspection of a container. In this connection, for example, one or more light barriers may be provided, which are particularly suitable for detecting a position of the containers on the transport device. In response to this position, a measurement can be triggered by means of the sensor device.

Particularly preferably, the apparatus therefore has a position detection device that is suitable and intended for detecting the position of the containers or of a particular container along the transport path.

In a further advantageous embodiment, the first actuator device is arranged laterally next to the transport path or below the transport path. The actuator device can have an active element that, for example, can be moved in a straight line and/or is perpendicular to the transport path. In a preferred embodiment, the actuator device can be actuated electrically and/or pneumatically and/or hydraulically. Particularly preferably, the actuator device has a contact element that is suitable and intended for contacting the containers in a specific region, and in particular for discharging them from the transport path.

Preferably, the fieldbus is an Ethernet-based fieldbus. In particular, it is an Ethernet-based real-time fieldbus. Particularly preferably, this fieldbus uses real-time-capable protocols and, in particular, standardized, hard real-time-capable protocols. In particular, the fieldbus uses protocols that use Ethernet hardware, such as Profinet-RT/IRT, EtherCAT, Ethernet-IP.

If, for example, EtherCAT is used as the bus protocol, then a large number of standard-compliant bus participants from various manufacturers and suppliers are available, which may be easily adapted. These allow highly deterministic data transmission with cycle times down to 100 μs and latencies down to 10 μs. The possible line lengths amount to several 10 m between each two participants. In addition, extensive engineering and diagnostic tools are available, making use in practice very easy.

In a preferred embodiment, both the first sensor device and the first actuator device are connected to the control device at least in sections via the same cable connection. Particularly preferably, only one cable connection is provided, which connects the first sensor device and/or the first actuator device to the control device.

In a further advantageous embodiment, data communication between the sensor device and the control device along with a power supply for the sensor device and/or the actuator device is carried out via such cable connection. A low voltage or low current supply is particularly preferred.

Particularly preferably, several instruments or devices are connected with one data cable. Special circuit devices such as switches are particularly preferred here. In addition, a “daisy chain,” i.e., a serial connection, can also be provided, with which respectively the output of the upstream bus participant is preferably connected to the input of the downstream bus participant. As mentioned above, preferably both a power supply for the sensor device and the sensor data run over a cable connection or over the same cable. This cable connection can be a hybrid cable that uses separate supply and data conductors. In addition, however, the same conductor can also be used, such as in the case of the above-mentioned PoE.

With the invention, complex sensor or actuator systems with a large number of sensors and actuators may also be constructed highly efficiently and cost-effectively. Especially in the case of daisy chain cabling, with which each instrument or device has an input socket and an output socket, or an input connection and an output connection, it is preferable to have only one cable harness.

This is particularly advantageous if several sensor devices and actuator devices are present, and these are arranged in particular one after the other on a transport path. In this way, in the case of an extension of up to 100 m and more, high efficiency and low costs can be achieved, in contrast to, for example, a solution in which each individual sensor device is wired in parallel and/or separately.

Preferably, at least the actuator device and/or the sensor device and/or the control device has both a first interface, such as an input interface, and a second interface, such as an output interface. Preferably, all sensor devices and all actuator devices each have an input interface and an output interface.

In the case of free-running systems, which supply data in particular cyclically in a fixed time window, linking with trigger signals or other data essential for evaluation, such as a speed of movement of the objects to be measured, can be carried out more efficiently.

The real-time-capable, Ethernet-based fieldbus also preferably enables larger amounts of data to be transmitted in non-real-time in parallel with real-time communication, such as parameters or diagnostic data.

Particularly preferably, the control device is also in communication connection with a drive device that drives the transport device. In this way, for example, data regarding the transport of the containers, such as, in particular, but not exclusively, a transport speed, may be read in.

In a further advantageous embodiment, the apparatus has an evaluation device that evaluates the data output by the sensor device. In particular, this evaluation device is also spaced apart from the sensor device and/or the actuator device. Preferably, this evaluation device is a component of the control device and/or is integrated into it.

In a further preferred embodiment, the first actuator device is in communication connection (with the control device) via the first sensor device of the control device, and/or the first sensor device is in communication connection with the control device via the first actuator device.

In a further preferred embodiment, the first sensor device is connected to the first actuator device via a direct communication connection and in particular a cable connection, and in particular is in communication connection. Particularly preferably, the first sensor device, the first actuator device, and the control device are connected via only one cable connection. In particular, as mentioned above, such devices are connected to one another in series—in particular, via a so-called daisy chain.

Daisy chain is the term used to describe a number of hardware components that are connected to one another in series—usually in so-called bus systems in automation technology.

Thereby, a first component is often directly connected to a computer system—here, the control device. The other components are each connected to their predecessors, i.e., a series circuit principle is present. In this way, a chain is created.

Particularly preferably, a signal to and from a component such as, in this case, the actuator device or the sensor device is delivered only via its predecessor to the control device.

Particularly preferably, priorities can be assigned with regard to the individual devices. For example, it can be specified that information be transmitted only if the line is free, or that some components have absolute priority over other components. In this way, conflicts and malfunctions can be prevented.

In a further advantageous embodiment, the first sensor device has an image recording device that is suitable and intended for recording two-dimensional images. Preferably, the sensor device is capable of outputting data, which allows a plurality of values of individual image pixels to be output.

Preferably, the first sensor device is suitable and intended for recording spatially-resolved images of the containers. In particular, these are color images. Preferably, therefore, the first sensor device has an array for recording images. However, the use of line sensors would also be conceivable.

In a preferred embodiment, the apparatus further has an illumination device that is suitable and intended for illuminating the containers to be inspected. This allows for incident light inspection, in which the containers are illuminated, and the image recording device records images from a different direction. In addition, a transmitted light inspection can also be provided, where the containers are illuminated from behind, as is possible, for example, with a fill-level inspection.

Preferably, the illumination device is suitable and intended for outputting diffuse radiation onto the containers to be inspected. In a further advantageous embodiment, the illumination device is suitable and intended for outputting directed radiation onto the containers.

Furthermore, this illumination device is preferably assigned to the sensor device and can preferably be released and/or triggered together with the sensor device.

In a further preferred embodiment, the data from at least two, and preferably from several, sensor devices are processed, and, in particular, processed and/or evaluated, at a distance from these, and, particularly preferably, centrally. Particularly preferably, the processing and/or evaluation of such data also takes place at a distance from the actuator devices. Particularly preferably, data processing is not performed decentrally at the sensor device, but centrally at the control device.

In a further advantageous embodiment, the value characteristic of the container is characteristic of a property of the container selected from a group of properties that includes a fill-level of the liquid contained in the container, a tightness of a container closed with a closure, a Brix value, a pressure of a gaseous medium within the container, a faultiness of a closure or a mouth of the container, and the like.

Preferably, the transport device is a transport device that transports the containers in a straight line. Particularly preferably, the transport device is a transport device that transports the containers in a single path. For example, it can be a conveyor belt on which the containers are transported, in particular, in an upright position. However, it would also be possible for the containers to be guided by their sides, or even by their closures or mouths. Furthermore, the containers can be plastic bottles in particular, but also glass bottles or cans.

Particularly preferably, the apparatus has at least one second sensor device and/or at least one second actuator device. Particularly preferably, both a second sensor device and a second actuator device are provided. Thereby, it is possible for the first and second sensor devices to detect different properties of the containers. However, it would also be conceivable for the sensor devices to each detect the same properties of the containers. In addition, more than two sensor devices and/or more than two actuator devices may also be used. Particularly preferably, several, and particularly preferably all, sensor and/or actuator devices are serially connected to one another, and in particular are each connected with real-time-capable buses.

In a preferred embodiment, at least two sensor devices are provided, which detect measured values of the transported containers from different directions and/or record images of the transported containers from different directions.

Particularly preferably, the several sensor devices are arranged one after the other and, particularly preferably, are arranged one after the other along the transport path of the containers. In a further preferred embodiment, the several actuator devices are also arranged in series. Particularly preferably, first, all sensor devices are provided, and, then, all actuator devices. However, it would also be possible for a sensor device to be provided first, then an actuator device, then a second sensor device, and then a second actuator device. Particularly preferably, however, all sensor devices and/or all actuator devices are in communication connection with the control device.

Particularly preferably, the control device evaluates data from both the first and second sensor devices.

The present invention is further directed to a facility for handling containers. This facility has a first handling device that handles the containers in a first predetermined manner. Furthermore, the facility has a second handling device that handles the containers in a second predetermined manner. Furthermore, the facility has an apparatus for handling and, in particular, inspecting containers of the type described above. According to the invention, the apparatus for inspecting the containers is arranged between the first handling device and the second handling device.

Particularly preferably, the first handling device is selected from a group of handling devices that includes forming devices for forming plastic parisons into plastic containers, sterilization devices for sterilizing containers, filling devices for filling containers, closing devices for closing containers with container closures, labeling devices for labeling containers or printing devices for the printing of containers, or the like.

Particularly preferably, the second handling device is selected from a group of handling devices that includes, in particular, sterilization devices for sterilizing containers, filling devices for filling containers, and closing devices for closing containers with closures, and palletizing devices and labeling devices.

The present invention is further directed to a method for handling and, in particular, inspecting containers and, in particular, beverage containers. A transport device transports the containers along a predetermined transport path, and a first sensor device detects at least one value characteristic of the transported containers. Furthermore, a first actuator device acts upon (at least) one transported container and discharges it from the transport path in particular.

Furthermore, a control device controls the first actuator device, taking into account at least one signal and/or value output by the first sensor device.

According to the invention, the first sensor device and the first actuator device are in communication connection with the control device via a cable connection by means of a real-time-capable fieldbus, and the first sensor device outputs measurement data characteristic of the containers in real time, wherein communication between the sensor device and the control device also take place in real time. Preferably, communication between the control device and the actuator device also takes place in real time.

Particularly preferably, the transport device transports the containers at a transport speed that is greater than 0.1 m/s. Particularly preferably, the transport device transports the containers at a transport speed that is less than 10 m/s.

In a further preferred method, a distance between the transported containers is greater than 1 cm, preferably greater than 2 cm, and preferably greater than 3 cm. Particularly preferably, the distance between the transported containers (in particular, the front wall of a first container to the rear wall of a second container) is less than 30 cm, preferably less than 20 cm, preferably less than 15 cm, preferably less than 10 cm, and particularly preferably less than 8 cm.

Particularly preferably, the distance between the successively transported containers is between a quarter container diameter and a full container diameter.

Particularly preferably, the containers are filled containers and, particularly preferably, sealed containers. Furthermore, the containers may have prints and/or labels.

In a further preferred method, several sensor devices and/or several actuator devices are provided, and these are connected to the control device at least in sections via the same cable connection. Particularly preferably, several sensor devices, and, particularly preferably, all sensor devices, communicate in real time with the control device.

Particularly preferably, the sensor device outputs complex data.

Particularly preferably, the method described here is carried out for quality inspection and/or quality assurance of the containers.

Further advantages and embodiments emerge from the accompanying drawing.

### BRIEF DESCRIPTION OF THE DRAWINGS

In the drawings:

FIG. 1 shows a schematic representation of an apparatus according to the invention.

### DETAILED DESCRIPTION OF THE INVENTION

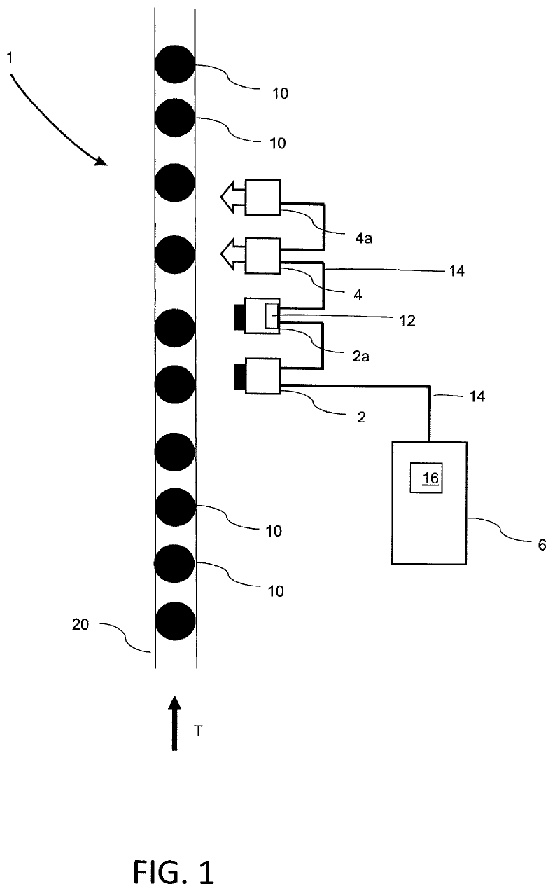

FIG. 1 shows a schematic representation of an apparatus 1 according to the invention. This has a transport device 20, e.g., a conveyor belt 20, which transports the containers 10 along a preferably straight-line transport path T.

The reference signs 2 and 2a designate two sensor devices that are suitable and intended for detecting properties of the containers 10 transported by the transport device 20, and in particular for contactless, and, in particular, optical detection.

The reference signs 4 and 4a designate two actuator devices, which are arranged along the transport path T downstream of the sensor devices 2, 2a and which serve in particular to discharge the containers 10 from the transport path T—in particular, in response to a signal output by at least one of the sensor devices 2, 2a.

The reference sign 6 designates a control device of the apparatus. In particular, this control device controls the actuator devices 4, 4a in response to signals output by the sensor devices 2, 2a.

The individual sensor devices 2, 2a and actuator devices 4, 4a, and preferably also the control device 6, are each equipped with real-time fieldbuses 12, although only one such fieldbus is shown in FIG. 1.

In addition, the sensor devices 2, 2a and actuator devices 4, 4a, and preferably also the control device 6, are connected to one another via a single cable connection 14. However, this cable connection can also be made up of individual connecting devices, which connect the sensor devices 2, 2a and preferably also the actuator devices 4, 4a and the control device 6 to one another.

Preferably, the control device 6 has an evaluation device that, in particular, evaluates the data and/or signals output by the sensor device or devices and, preferably, as a result of this evaluation, actuates one of the actuator devices in order to discharge a corresponding container 10 from the transport path.

For example, the sensor device 2 is a line sensor that preferably provides an array of measured values as complex data, wherein the measured values particularly preferably represent absorbance values recorded with a vertically-arranged sensor array. Such values are transmitted cyclically via the cable connection 14 to the control device 6, which calculates from the signals a fill-level of a product in the containers 10. Based upon deterministic data transmission, such fill-level values and the OK/NOK information derived from them may be assigned to individual containers 10.

The sensor device 2a could be a camera unit that determines the fit of the closures on the containers 10. This unit could determine, as complex data, the positions of the closures relative to the containers 10 along with their angle to the horizontal. These data are also transmitted via the cable connection 14 to the control device 6, which derives OK/NOK information from the position and angle data, and in turn assigns it to the individual containers 10.

In the example, the actuator device 4 would be the preferred flashed illumination unit, which serves the camera unit 2a for optimal illumination of the containers. Via the cable connection 14, this receives the information for highly synchronous flash control.

In this example, the actuator device 4a would be the rejection unit arranged downstream. This receives, also via the cable connection 14, the information for the position-specific rejection of the NOK (not ok) containers 10. The rejection itself can be pneumatic, in which case a solenoid valve would be activated at exactly the right time to activate the compressed air. Otherwise, rejection can also be performed by servo motor, in which case the rejection process is triggered electrically.

The applicant reserves the right to claim all features disclosed in the application documents as essential to the invention, provided that they are novel over the prior art individually or in combination. It is also pointed out that features which can be advantageous in themselves are also described in the individual figures. The person skilled in the art will immediately recognize that a particular feature described in a figure can be advantageous even without the adoption of further features from this figure. Furthermore, the person skilled in the art will recognize that advantages can also result from a combination of several features shown in individual or in different figures.

1. An apparatus for handling containers, having a transport device that is configured for transporting the containers along a predetermined transport path, having a first sensor device that is configured for detecting at least one value characteristic of the transported containers, having a first actuator device that is arranged along the transport path downstream of the first sensor device and that is configured for acting upon a transported container, and having a control device that is spaced apart from the sensor device and the actuator device and that is configured for controlling the first actuator device, taking into account at least one signal output by the first sensor device, as a function of the characteristic value,
wherein
the first sensor device and the first actuator device are in communication connection with the control device via a cable connection using a real-time-capable fieldbus, and the first sensor device is configured for outputting measurement data in real time, and the communication between the first sensor device and the control device and/or the control device and the first actuator device takes place in real time.

2. The apparatus according to claim 1,
wherein
the fieldbus is an Ethernet-based fieldbus.

3. The apparatus according to claim 1,
wherein
both the first sensor device and the first actuator device are connected to the control device at least in sections via the same cable connection.

4. The apparatus according to claim 3,
wherein
data communication between the sensor device and the control device along with a power supply of the sensor device and/or the actuator device is carried out via such cable connection.

5. The apparatus according to claim 1,
wherein
the apparatus has an evaluation device that evaluates the data output by the sensor device, wherein the evaluation device is spaced apart from the sensor device and/or the actuator device.

6. The apparatus according to claim 1,
wherein
the first actuator device is in communication connection with the control device via the first sensor device, and/or the first sensor device is in communication connection with the control device via the first actuator device.

7. The apparatus according to claim 1,
wherein
the first sensor device is connected to the first actuator device via a direct communication connection.

8. The apparatus according to claim 1,
wherein
the first sensor device has an image recording device that is configured for recording two-dimensional images.

9. The apparatus according to claim 1,
wherein
the value characteristic of the container is characteristic of a property of the container selected from a group of properties that includes a fill-level of the container with a filling product, a tightness of a container closed with a closure, a Brix value, a pressure of a gaseous medium inside the container.

10. The apparatus according to claim 1,
wherein
the apparatus has at least one second sensor device and/or at least one second actuator device.

11. A method for handling containers, wherein a transport device transports the containers along a predetermined transport path, and a first sensor device detects at least one value characteristic of the transported containers, and a first actuator device acts upon a transported container, and wherein a control device controls the first actuator device, taking into account at least one signal output by the first sensor device,
wherein
the first sensor device and the first actuator device are in communication connection with the control device via a cable connection using at least one, real-time-capable fieldbus, and the first sensor device outputs measurement data characteristic of the containers in real time, wherein communication between the sensor device and the control device takes place in real time.

12. The method according to claim 11,
wherein
several sensor devices and/or several actuator devices are provided, and these are connected to the control device at least in sections via the same cable connection.

13. The method according to claim 11,
wherein
the sensor device outputs complex data.

14. The method according to claim 11,
wherein
the method is carried out for quality inspection and/or quality assurance of the containers.
